(19) United States
(12) Patent Application Publication
(10) Pub. No.: US 2019/0121195 A1
(43) Pub. Date: Apr. 25, 2019

(54) DISPLAY DEVICE AND PRODUCTION METHOD THEREFOR

(71) Applicant: SHARP KABUSHIKI KAISHA, Sakai City, Osaka (JP)

(72) Inventor: TADASHI KITABAYASHI, Sakai City (JP)

(21) Appl. No.: 16/096,411

(22) PCT Filed: Apr. 20, 2017
(86) PCT No.: PCT/JP2017/015884

§ 371 Date: Oct. 25, 2018

(30) Foreign Application Priority Data
Apr. 27, 2016 (JP) 2016-089627

(51) Int. Cl. G02F 1/1335; G02B 5/30

(52) U.S. Cl. CPC G02F 1/133528; G02F 1/133305; G02B 5/3025

(57) ABSTRACT

A liquid-crystal display device having a curved surface shape includes a liquid-crystal display panel and a polarizing plate laminated on the liquid-crystal display panel. The polarizing plate is laminated with tension applied to the polarizing plate to exert a compression stress on the liquid-crystal display panel.

### TECHNICAL FIELD

The present invention relates to a display device including, for example, a liquid-crystal display device and particularly relates to a display device used in a curved state.

### BACKGROUND ART

Today's progressing information society has increased in the demand for curved liquid-crystal display devices having a curved surface shape, compared to those having a flat surface shape.

To satisfy the demand, a curved liquid-crystal display device produced, for example, using a stage having a convex surface has been suggested. Specifically, a first polarizing plate is held on a stage having a convex surface curved at a predetermined curvature to conform to the convex surface, a liquid-crystal display panel with a glass substrate is brought into contact with the held first polarizing plate to partially overlap with the held first polarizing plate, and the liquid-crystal display panel is pressed against the first polarizing plate along the convex surface of the stage from the overlapping portion, thereby laminating the curved liquid-crystal display panel to the held first polarizing plate to conform to the first polarizing plate. Next, a second polarizing plate is brought into contact with the curved and laminated liquid-crystal display panel to partially overlap with the panel, and sequentially the second polarizing plate is pressed against the liquid-crystal display panel along the convex surface of the stage from the overlapping portion, thereby laminating the second polarizing plate to the curved and laminated liquid-crystal display panel to conform to the liquid-crystal display panel. A curved liquid-crystal display device thus produced is disclosed (see, for example, Patent Document 1).

As another example, a liquid-crystal display device is described. The liquid-crystal display device includes a curved liquid-crystal display panel having glass substrates, a frame holding the liquid-crystal display panel in a curved state, and resin sheets laminated on a display surface and a back surface of the liquid-crystal display panel with adhesive layers interposed therebetween. On at least one of the curved surfaces of the laminate, the strength of adhesion between the resin sheet and the liquid-crystal display panel or the degree of relaxation for the shear stress is different between the central area of the curved surface and both end regions thereof.

### CITATION LIST

### Patent Document

PATENT DOCUMENT 1: Japanese Unexamined Patent Publication No. 2009-237278

PATENT DOCUMENT 2: Japanese Unexamined Patent Publication No. 2015-106045

### SUMMARY OF THE INVENTION

### Technical Problem

In the liquid-crystal display device described in Patent Document 1, the liquid-crystal display panel is pressed against the first polarizing plate along the convex surface of the stage and is laminated on the first polarizing plate held by the stage while being curved along the first polarizing plate. In this process, the liquid-crystal display panel is curved with a tensile stress applied to the convex surface of the laminated liquid-crystal display panel, which increases the tensile stress on the convex surface side of the liquid-crystal display panel. The tensile stress may problematically cause damage such as a crack to the liquid-crystal display panel.

The liquid-crystal display panel described in Patent Document 2 configured to hold the curved liquid-crystal display panel by a frame has a problem in that a recovery stress of the curved liquid-crystal display panel concentrates on the frame portion, resulting in damage such as a crack to the liquid-crystal display panel.

Furthermore, a surface of a glass substrate typically has a number of cracks. The above-described tensile stress concentrates particularly on the largest crack and accordingly extends the crack, which problematically causes breakage of the liquid-crystal display panel.

Such a known liquid-crystal display panel further has a problem in long-term reliability of the glass, because in a high humidity atmosphere under circumstances where a tensile stress above a certain level is exerted, moisture breaks a bond of glass and accelerates extension of a crack, resulting in a fatigue fracture.

In view of the foregoing background, it is therefore an object of the present invention to provide a curved display device capable of effectively reducing damage such as breakage.

### Solution to the Problem

In order to achieve the above object, a display device of the present invention has a curved surface shape and includes a display panel and a film laminated on the display panel. The film is laminated on the display panel with tension applied to the film to exert a compression stress on the display panel.

A production method for a display device of the present invention is a method for producing a display device having a curved surface shape and including a display panel and a film laminated on the display panel. In this method, the film is laminated on the display panel with tension applied to the film to exert a compression stress on the display panel.

### Advantages of the Invention

According to the present invention relating to a curved display device, damage such as breakage can be effectively reduced, and long-term reliability is therefore ensured.

### BRIEF DESCRIPTION OF THE DRAWINGS

FIG. 1 is a cross-sectional view of a curved liquid-crystal display device according to an embodiment of the present invention.

FIG. 2 is a schematic diagram of an overall structure of a polarizing plate lamination device according to the embodiment of the present invention.

FIG. 3 is a schematic diagram illustrating a method of laminating a polarizing plate using a polarizing plate lamination device according to the embodiment of the present invention.

FIG. 4 is another schematic diagram illustrating the method of laminating a polarizing plate using a polarizing plate lamination device according to the embodiment of the present invention.

FIG. 5 is still another schematic diagram illustrating the method of laminating a polarizing plate using a polarizing plate lamination device according to the embodiment of the present invention.

FIG. 6 is still another schematic diagram illustrating the method of laminating a polarizing plate using a polarizing plate lamination device according to the embodiment of the present invention.

FIG. 7 is a diagram illustrating a force exerted on the liquid-crystal display panel of the curved liquid-crystal display device according to the embodiment of the present invention.

FIG. 8 is a diagram illustrating residual stress on the curved liquid-crystal display device according to the embodiment of the present invention.

FIG. 9 is a cross-sectional view of a curved liquid-crystal display device according to a variation.

FIG. 10 is a diagram illustrating a force exerted on the liquid-crystal display panel of the curved liquid-crystal display device according to the variation of the present invention.

FIG. 11 is a diagram illustrating residual stress on the curved liquid-crystal display device according to the variation of the present invention.

FIG. 12 is a diagram illustrating a force exerted on a liquid-crystal display panel of a known curved liquid-crystal display device.

FIG. 13 is a diagram illustrating a tensile stress on the known curved liquid-crystal display device.

### DESCRIPTION OF EMBODIMENTS

Embodiments of the present invention will now be described in detail with reference to the drawings. It should be noted that the present invention is not limited to the following embodiments.

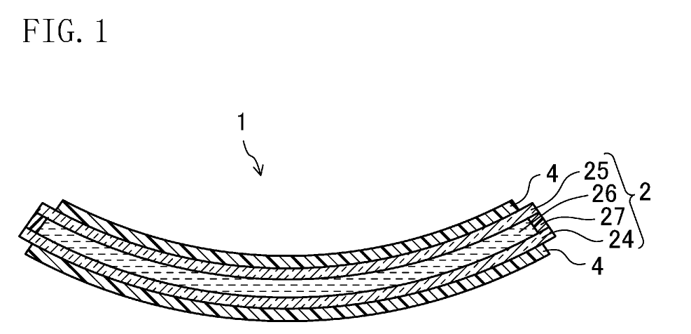

FIG. 1 is a cross-sectional view of a curved liquid-crystal display device according to an embodiment of the present invention.

As illustrated in FIG. 1, a liquid-crystal display device 1 according to the embodiment includes a liquid-crystal display panel 2 including a thin film transistor (TFT) substrate 24, a color filter (CF) substrate 25 facing the TFT substrate 24, a liquid-crystal layer 26 arranged between the TFT substrate 24 and the CF substrate 25, and a frame-shaped sealing member 27 for bonding the TFT substrate 24 and the CF substrate 25 to each other and sealing the liquid-crystal layer 26.

The sealing member 27 is formed to surround the liquid-crystal layer 26, and the TFT substrate 24 and the CF substrate 25 are bonded to each other with the sealing member 27 interposed therebetween.

The TFT substrate 24 includes, for example, a glass substrate (not illustrated), and on the glass substrate, TFT elements such as a gate electrode, a source electrode, and a drain electrode, an insulating layer, pixel electrodes, an alignment film, and other components, which are not illustrated.

The CF substrate 25 includes, for example, a glass substrate (not illustrated), and on the glass substrate, a black matrix (not illustrated) forming a lattice pattern and a frame serving as a light-blocking portion, and a color filter (not illustrated) including a plurality of types of color layers (which are a red layer R, a green layer G, and a blue layer B) formed between the lattice arrays of the black matrix and provided for respective pixels. The CF substrate 25 further includes a common electrode (not illustrated) arranged to cover the black matrix and the color filter, columnar photo spacers arranged on the common electrode or resin bead spacers (not illustrated), and an alignment film (not illustrated) arranged to cover the common electrode.

The liquid-crystal layer 26 is formed of, for example, a nematic liquid-crystal material having electro-optic properties.

The liquid-crystal display device 1 includes polarizing plates 4 in the form of a film laminated on the liquid-crystal display panel 2. A known polarizing film is preferably used as the polarizing plate 4. More specific examples of such a polarizing film 4 include a known polarizing plate that has protection coatings adhering to both surfaces of a film polarizer and has an adhesive layer disposed on each of the protection coatings.

The respective polarizing plates 4 are laminated on both surfaces of the liquid-crystal display panel 2 to cover the entire surface of a display area (an entire portion serving as a display screen) of the liquid-crystal display panel 2. The polarizing plate 4 may have a thickness of, for example, from 10 μm to 300 μm, although not limited to this range.

One of the adhesive layers is formed to laminate a release film to the film polarizer and to laminate the polarizing film to the liquid-crystal display panel 2. The other adhesive layer is formed to laminate a protection film to the film polarizer.

Examples of the film polarizer include a film obtained by providing uniaxial drawing and coloring processing using a dye such as iodine and other various processing such as hue adjustment, on a film made of, for example, hydrophilic polymer such as polyvinyl alcohol (PVA), partially formalized polyvinyl alcohol, a partially saponified product of ethylene vinyl acetate copolymer, and cellulose. A method of producing the film polarizer is not limited to those examples, and a known film polarizer is preferably used.

Examples of the protection coating include known films, such as a triacetylcellulose (TAC) film, a cycloolefin resin film, a resin film of cellulose acetate such as diacetylcellulose, a resin film of polyester such as polyethylene terephthalate (PET), polyethylene naphthalate, and polybutylene terephthalate, a polycarbonate resin film, an acrylic resin film, and a polypropylene resin film. The protection coating may have a thickness of, for example, from 10 μm to 100 μm, although not limited to this range.

As illustrated in FIG. 1, the liquid-crystal display device 1 of this embodiment is maintained in a curved state having a predetermined radius of curvature.

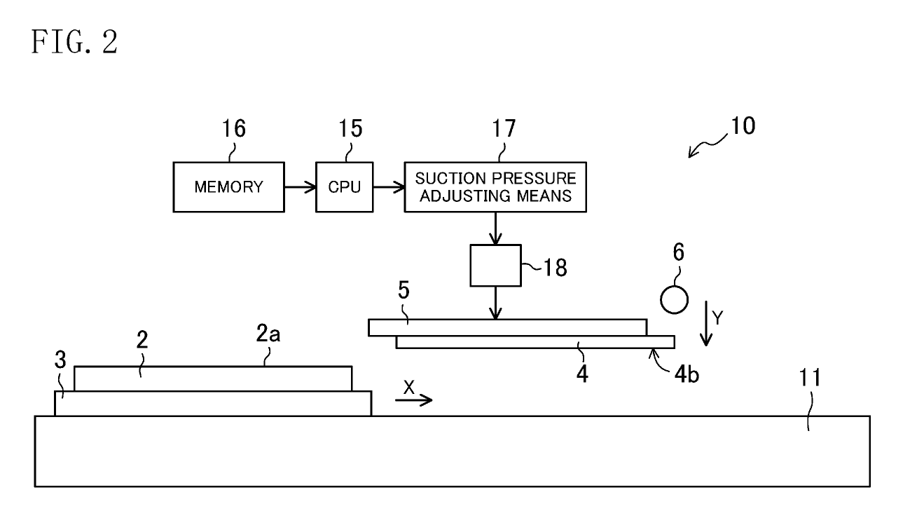

A production method for a liquid-crystal display device according to the embodiment of the present invention will now be described. FIG. 2 is a schematic diagram of an overall structure of a polarizing plate lamination device according to the embodiment of the present invention.

As illustrated in FIG. 2, the polarizing plate lamination device 10 includes a panel suction-attraction stage 3 as panel holding means for holding the liquid-crystal display panel 2 to which the polarizing plate 4 is laminated, a polarizing plate suction-attraction stage (a film suction-attraction stage) 5 as polarizing plate holding means for holding the polarizing plate 4, a lamination roller 6 as laminating means for laminating the polarizing plate 4 to a surface of the liquid-crystal display panel 2 by pressing the polarizing plate 4 against the liquid-crystal display panel 2.

The panel suction-attraction stage 3 is connected to a vacuum device (not illustrated) and is configured to hold the liquid-crystal display panel 2 by suction attraction. The polarizing plate lamination device 10 further includes a conveyor belt 11 as conveying means for conveying the liquid-crystal display panel 2 held by the panel suction-attraction stage 3 toward the polarizing plate 4. The conveyor belt 11 is configured to convey the liquid-crystal display panel 2 held by the panel suction-attraction stage 3 toward the polarizing plate 4 (the direction of arrow X illustrated in FIG. 1) at a predetermined speed.

Upon placement of the panel suction-attraction stage 3 holding the liquid-crystal display panel 2 on the conveyor belt 11, the conveyor belt 11 conveys the liquid-crystal display panel 2 held by the panel suction-attraction stage 3 in the direction of arrow X illustrated in FIG. 1.

The conveyor belt 11 may be replaced by a cylinder having a linear motion (LM) guide or a stepper motor drive stage.

The polarizing plate suction-attraction stage 5 is connected to a vacuum device 18 and holds the polarizing plate 4 by means of suction attraction using a suction force generated by the vacuum device 18.

As illustrated in FIG. 2, the polarizing plate 4 is suctionally attracted with its laminating margin portion 4b protruding beyond an end portion of the polarizing plate suction-attraction stage 5 provided with the lamination roller 6.

The lamination roller 6 laminates the polarizing plate 4 to the liquid-crystal display panel 2 by pressing the polarizing plate 4 against the liquid-crystal display panel 2. The lamination roller 6 is in the shape of a rod having a circular sectional surface and is rotatable around a rotation axis consistent with the center axis of the circle of the sectional surface. The lamination roller 6 moves in the direction of arrow Y in FIG. 2 and presses the polarizing plate 4.

As illustrated in FIG. 2, the lamination roller 6 is disposed near an end portion (remote from the panel suction-attraction stage 3) of the polarizing plate suction-attraction stage 5 in the direction X of conveyance of the panel suction-attraction stage 3.

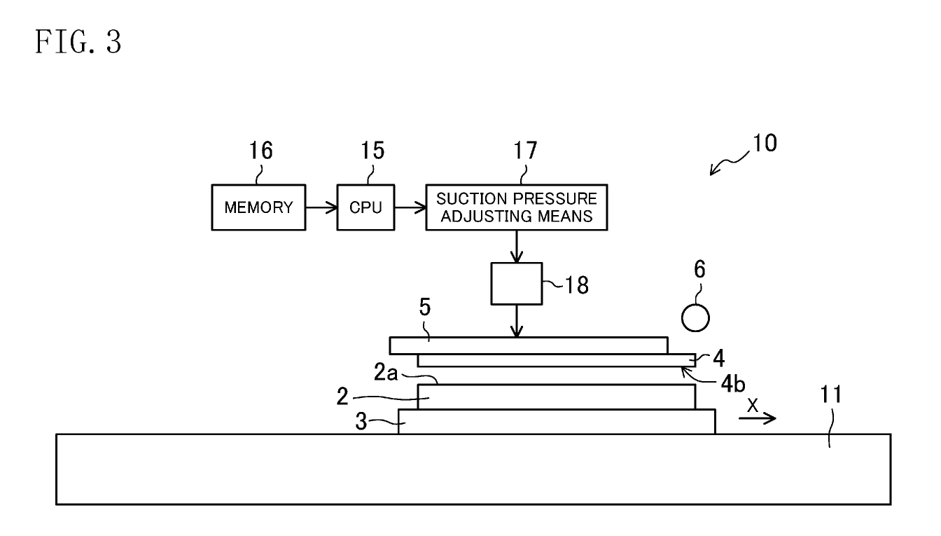

A method of laminating polarizing plates 28 and 29 to the liquid-crystal display panel 2 using the polarizing plate lamination device 10 will now be described. FIGS. 3 to 6 are schematic diagrams illustrating a method of laminating a polarizing plate using a polarizing plate lamination device according to the embodiment of the present invention.

The liquid-crystal display panel 2 is first placed on the panel suction-attraction stage 3. With the panel suction-attraction stage 3 holding the liquid-crystal display panel 2 by suction attraction, a surface 2a of the liquid-crystal display panel 2 to which the polarizing plate 4 is laminated is cleaned with a cleaning cloth made of a fiber material having a solvent (such as isopropanol and acetone) impregnated.

As illustrated in FIG. 3, the liquid-crystal display panel 2 held by the panel suction-attraction stage 3 is conveyed by the conveyor belt 11 toward the polarizing plate 4 (in the direction of arrow X). The speed of conveyance of the liquid-crystal display panel 2 is constant (for example, 100 mm/s).

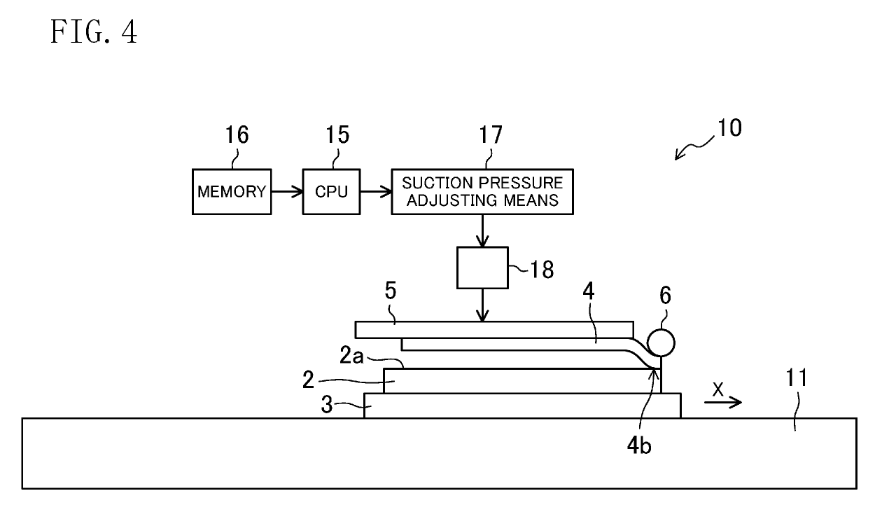

As illustrated in FIG. 4, after the liquid-crystal display panel 2 held by the panel suction-attraction stage 3 moves to a lamination position for the polarizing plate 4, the lamination roller 6 moves in the direction of the above-described arrow Y and presses the polarizing plate 4 until a front end of the laminating margin portion 4b of the polarizing plate 4 contacts the liquid-crystal display panel 2. The lamination roller 6 then applies pressure to the liquid-crystal display panel 2 through the front end of the laminating margin portion 4b of the polarizing plate 4 and laminates the front end of the laminating margin portion 4b of the polarizing plate 4 to an end of the liquid-crystal display panel 2.

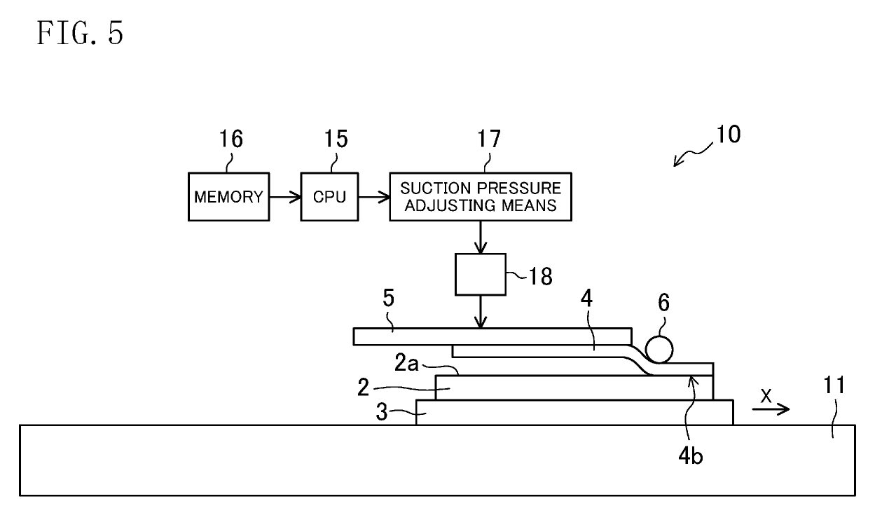

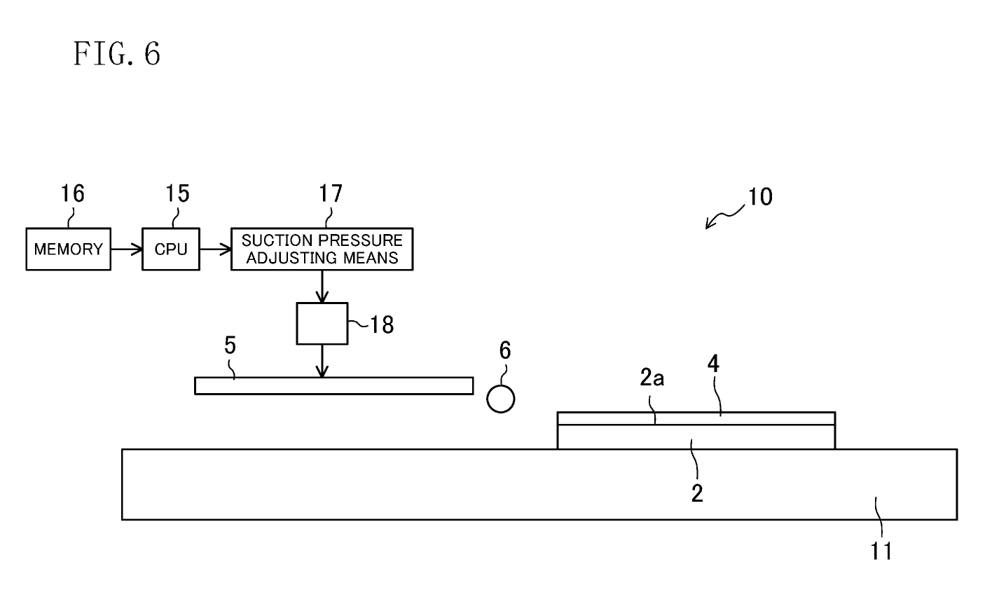

As illustrated in FIG. 5, the liquid-crystal display panel 2 held by the panel suction-attraction stage 3 moves in the conveyance direction X with the polarizing plate 4 held by the polarizing plate suction-attraction stage 5. In this process, the liquid-crystal display panel 2 moves in the direction X while the lamination roller 6 presses the polarizing plate 4 and the liquid-crystal display panel 2. This allows the polarizing plate 4 to be pressed against the entire surface 2a of the liquid-crystal display panel 2 and accordingly allows the polarizing plate 4 to be laminated on the surface 2a of the liquid-crystal display panel 2 as illustrated in FIG. 6.

The above lamination processing is performed for each polarizing plate 4 to laminate the polarizing plates 4 on the liquid-crystal display panel 2. Thus, the curved liquid-crystal display device 1 illustrated in FIG. 1 is produced.

In this embodiment, the polarizing plate 4 is laminated on the liquid-crystal display panel 2 with tension applied to the polarizing plate 4 to exert a compression stress on the liquid-crystal display panel 2.

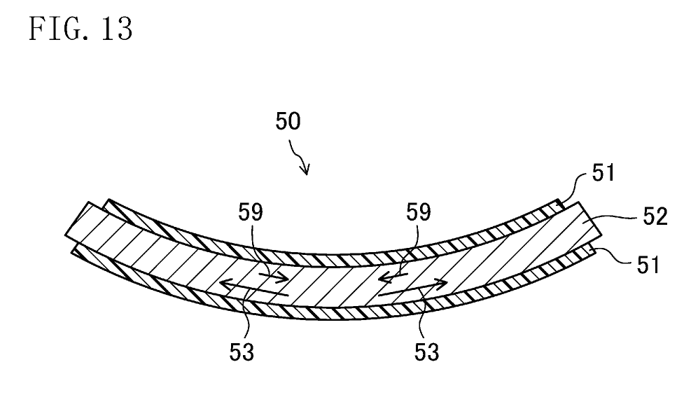

That is to say, as described above, in a known liquid-crystal display device 50, a liquid-crystal display panel 52 is laminated on a polarizing plate 51 while being pressed along the convex surface of the stage. In this lamination, a force (a force indicated by the reference numeral 58) as illustrated in FIG. 12 is applied to the liquid-crystal display panel, which causes, as illustrated in FIG. 13, the liquid-crystal display panel 52 to be curved with a tensile stress 53 generated on the convex surface of the liquid-crystal display panel 52. This configuration increases the tensile stress 53 on the convex surface of the liquid-crystal display panel 52 as illustrated in FIG. 13. This problematically causes damage such as a crack to the liquid-crystal display panel 52.

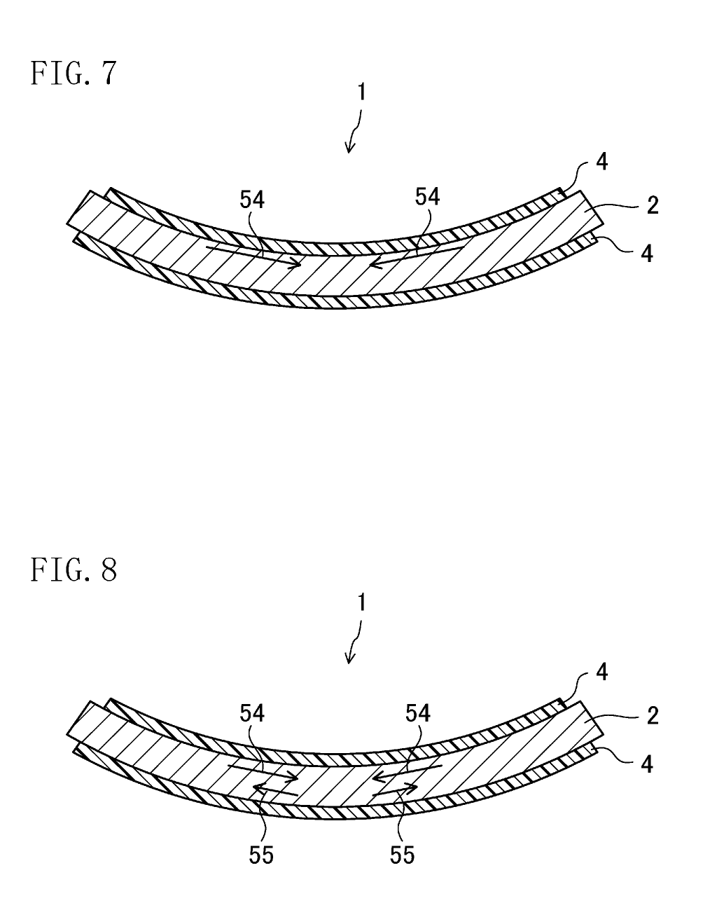

In the present invention, as illustrated in FIG. 7, the polarizing plate 4 is laminated on the liquid-crystal display panel 2 with tension applied to the polarizing plate 4 to exert a compression stress 54 on the liquid-crystal display panel 2. This allows residual stresses remaining in the produced curved liquid-crystal display device 1 to compensate for a tensile stress 55 corresponding to the exerted compression stress 54 as illustrated in FIG. 8, and can therefore reduce the tensile stress 55 near the convex surface of the liquid-crystal display panel 2. In this manner, damage such as breakage can be effectively reduced in the curved liquid-crystal display device 1.

Generally, a tensile stress is considered to be caused by a “thermal stress” (a difference in the thermal expansion coefficient between constituent materials) and a “mechanical stress”. The “mechanical stress” is considered to include a “static stress” (which results from bending, deformation, and other factors) and a “dynamic stress” (which results from contacts with a cassette, a jig, a frame, and other objects). In a high humidity atmosphere, when a tensile stress excessing a limit is exerted due to the above factors, moisture breaks the Si—O₂ bond of the glass substrate. The tensile stress accelerates extension of a crack on the glass substrate and thus causes a fatigue fracture.

In the present invention, as described above, the tensile stress 55 on the convex surface of the liquid-crystal display panel 2 can be decreased, which can prevent a fatigue fracture and therefore ensure long-term reliability.

The “compression stress” as used herein refers to a force exerted in directions indicated by the reference numeral 54 in FIG. 7, i.e., in directions in which the liquid-crystal display panel 2 shrinks.

The “tensile stress” as used herein refers to a force exerted in directions indicated by the reference numeral 55 in FIG. 8, i.e., in directions in which the liquid-crystal display panel 2 stretches.

In this embodiment, in lamination of the polarizing plate 4 to the liquid-crystal display panel 2, tension is applied to the polarizing plate 4 by adjusting the suction attraction force (in other words, a suction pressure to the polarizing plate 4) of the polarizing plate suction-attraction stage 5 to the polarizing plate 4.

More specifically, as illustrated in FIG. 2, the polarizing plate lamination device 10 includes suction pressure adjusting means 17 connected with the vacuum device 18 and adjusting the pressure of air suctioned by the polarizing plate suction-attraction stage 5 (i.e., the suction pressure of the polarizing plate suction-attraction stage 5), a central processing unit (CPU) 15 connected with the suction pressure adjusting means 17 and serving as control means, and a memory 16 connected with the CPU 15 and serving as storage means. The CPU 15 is configured to control the suction pressure adjusting means 17 in accordance with a program stored in the memory 16.

In this embodiment, the suction pressure adjusting means 17 enables control of the suction attraction force of the polarizing plate suction-attraction stage 5 by adjusting the suction pressure of the vacuum device 18. In this manner, the polarizing plate 4 can be laminated on the liquid-crystal display panel 2 with tension applied to the polarizing plate 4 to exert a compression stress on the liquid-crystal display panel 2.

In this embodiment, the polarizing plates 4 can be laminated on the liquid-crystal display panel 2 with tension applied to at least one of the polarizing plate 4 disposed on the front side (near the CF substrate 25) or the polarizing plate 4 disposed on the back side (near the TFT substrate 24). For example, the polarizing plate 4 on the back side is laminated on the liquid-crystal display panel 2 with no tension applied, and the polarizing plate 4 on the front side is laminated on the liquid-crystal display panel 2 having the backside polarizing plate 4 laminated thereon with tension applied to the front-side polarizing plate 4. In this manner, the bending-type liquid-crystal display device 1 illustrated in FIG. 1 may be produced.

Furthermore, a direction and an angle in/at which the axis of polarization moves when tension is applied to the polarizing plate 4 are measured. Then, to laminate the polarizing plate 4 on the liquid crystal display panel 2 with tension applied thereto, the polarizing plate 4 is moved at the same angle as the angle of the movement of the polarization axis in the direction opposite to the direction of the movement of the polarization axis. With this configuration, the axis of polarization having a desired angle is obtained on the laminated polarizing plate 4.

In production of the polarizing plate 4, the film polarizer is drawn in one direction to impart polarization properties to the film polarizer. Thus, applying tension in the same direction as the direction I which the film polarizer is drawn can prevent the axis of polarization from moving (being displaced).

According to the above-described embodiment, the following effects can be exerted.

(1) In this embodiment, the liquid-crystal display device 1 having a curved surface shape is configured such that the polarizing plate 4 is laminated on the liquid-crystal display panel 2 with tension applied to the polarizing plate 4 to exert a compression stress on the liquid-crystal display panel 2. In this manner, in the curved liquid-crystal display device 1, damage such as breakage can be effectively reduced, and long-term reliability is therefore ensured.

(2) Tension is applied to the polarizing plate 4 by adjusting the suction attraction force of the polarizing plate suction-attraction stage 5 to the polarizing plate 4. Tension thus can be applied to the polarizing plate 4 by a simple method.

(3) The display panel having films (polarizing plates) laminated can maintain the curved shape by itself, which makes it unnecessary to laminate the liquid-crystal display panel 2 on any curved retaining member or frame.

The above embodiment may be changed as described below.

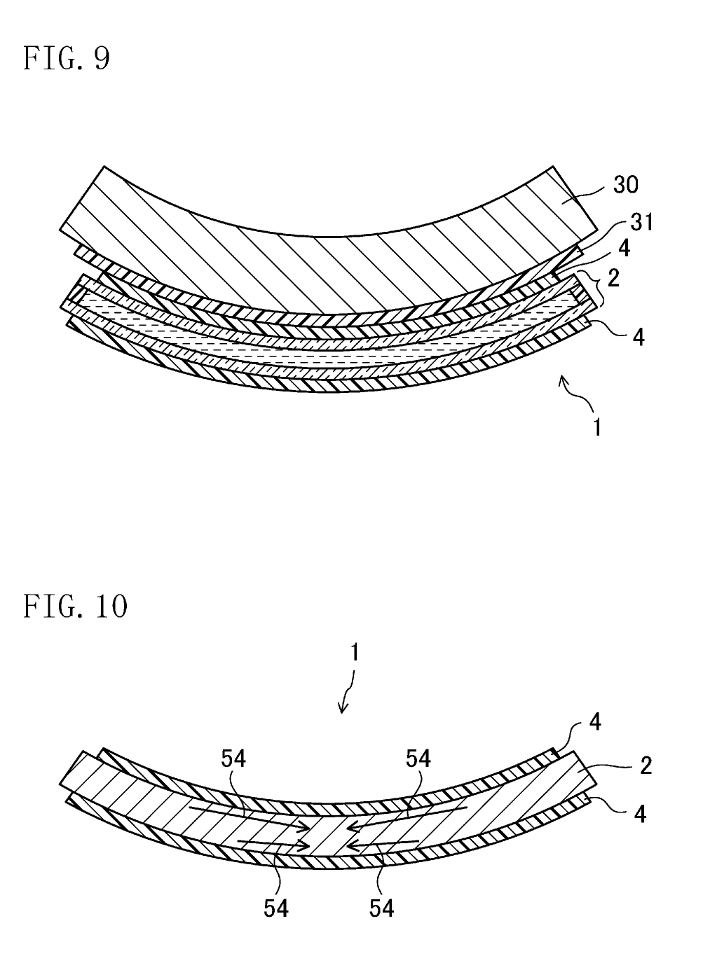

As illustrated in FIG. 9, the device may further include a retaining member 30 mounted to the polarizing plate 4 and retaining the curved surface shape. The retaining member 30 can effectively reduce damage such as breakage even if the liquid-crystal display panel 2 has a small thickness (for example, 0.3 mm). As illustrated in FIG. 9, the retaining member 30 is mounted to the front-side polarizing plate 4 with an adhesive layer 31 interposed therebetween.

In the above embodiment, tension is applied to the polarizing plate 4 by adjusting the suction attraction force of the polarizing plate suction-attraction stage 5 to the polarizing plate 4. However, tension may be applied to the polarizing plate 4 by setting the conveying speed of the liquid-crystal display panel 2 to be higher than the conveying speed of the polarizing plate 4, in the polarizing plate lamination process. This can also reduce the tensile stress 55 on the convex surface of the liquid-crystal display panel 2, and exerts the effects (1) and (2) of the above-described embodiment.

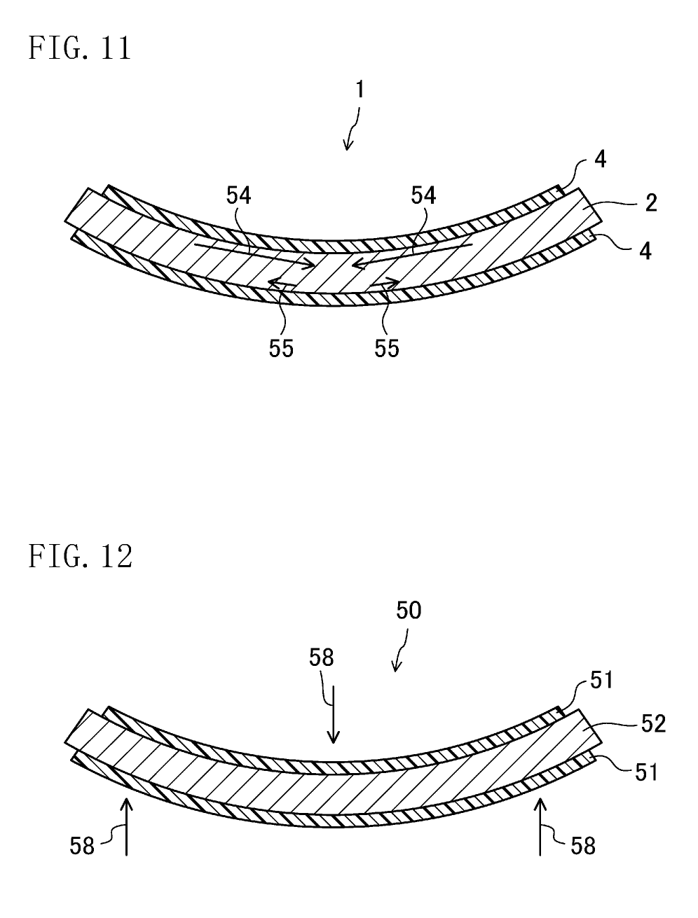

In the above embodiment, as illustrated in FIG. 7, the polarizing plate 4 is laminated on the liquid-crystal display panel 2 with tension applied thereto to exert the compression stress 54 on the concave surface of the liquid-crystal display panel 2. As illustrated in FIG. 10, the polarizing plate 4 may be laminated with tension applied thereto to further exert the compression stress 54 near the convex surface of the liquid-crystal display panel 2. This configuration allows residual stresses remaining in the produced curved liquid-crystal display device 1 to further compensate for the tensile stress 55 corresponding to the exerted compression stress 54 as illustrated in FIG. 11, and can therefore further reduce (to zero) the tensile stress 55 near the convex surface of the liquid-crystal display panel 2. In this manner, damage such as breakage can be further effectively reduced in the curved liquid-crystal display device 1.

In this case, as illustrated in FIG. 10, tension T₁ for the polarizing plate 4 near the concave surface of the liquid-crystal display panel 2 is set to be higher (T₁>T₂) than tension T₂ for the polarizing plate 4 near the convex surface of the liquid-crystal display panel 2 to make the compression stress 54 near the concave surface of the liquid-crystal display panel 2 larger than the compression stress 54 near the convex surface of the liquid-crystal display panel 2.

In the above embodiment, the polarizing plate 4 is used as an example of a film laminated on the liquid-crystal display panel 2. Other than the polarizing plate 4, examples of the film include a triacetylcellulose (TAC) film, a cycloolefin resin film, a resin film of cellulose acetate such as diacetylcellulose, a resin film of polyester such as polyethylene terephthalate (PET), polyethylene naphthalate, and polybutylene terephthalate, a polycarbonate resin film, an acrylic resin film, and a polypropylene resin film.

In the above embodiment, a liquid-crystal display panel is used as an example of a display panel. The present invention is further adaptable to other display panels such as an organic electro luminescence (EL) display panel, an inorganic EL display panel, and an electrophoresis display panel.

### INDUSTRIAL APPLICABILITY

As described above, the present invention relates to a display device such as a liquid-crystal display device and is useful particularly for a display device used in a curved state.

### DESCRIPTION OF REFERENCE CHARACTERS

1 Liquid-crystal Display Device
2 Liquid-crystal Display Panel (Display Panel)
4 Polarizing plate (Film)
5 Polarizing Plate Suction-Attraction Stage (Film Suction-Attraction Stage)
10 Polarizing Plate Lamination Device
17 Suction Pressure Adjusting Means
18 Vacuum Device
30 Retaining member
31 Adhesive Layer

1. A display device having a curved surface shape, the device comprising:
a display panel; and
a film laminated on the display panel, wherein
the film is laminated on the display panel with tension applied to the film to exert a compression stress on the display panel.

2. The display device of claim 1, further comprising
a retaining member that is mounted to the film and retains the curved surface shape.

3. The display device of claim 1, wherein
the film is a polarizing plate.

4. The display device of claim 1, wherein
the display panel is a liquid-crystal display panel.

5. A production method for a display device having a curved surface shape and including a display panel and a film laminated on the display panel, the production method comprising:
laminating the film on the display panel with tension applied to the film to exert a compression stress on the display panel.

6. The method of claim 5, further comprising:
having a film suction-attraction stage suctionally attract the film, and applying tension to the film by adjusting a suction attraction force of the film suction-attraction stage to the film in the laminating of the film on the display panel.

7. The method of claim 5, wherein
the film is a polarizing plate.

8. The method of claim 5, wherein
the display panel is a liquid-crystal display panel.
